(19) United States
(12) Patent Application Publication
(10) Pub. No.: US 2001/0032091 A1
(43) Pub. Date: Oct. 18, 2001

(54) Method and apparatus for providing intranet/web based programs

(76) Inventors: Michael A. Schultz, Southfield, MI (US); Michael E. Wegener, Southfield, MI (US)

Correspondence Address: Amy E. Rinaldo, Kohn & Associates, Suite 410, 30500 Northwestern Hwy., Farmington Hills, MI, 48334, US

(21) Appl. No.: 09/740,108

(22) Filed: Dec. 18, 2000

Related U.S. Application Data
(60) Provisional application No. 60/171,038, filed on Dec. 16, 1999.

(51) Int. Cl. G06F 17/60

(52) U.S. Cl. 705/1

(57) ABSTRACT

There is provided a business software program which provides an advisory report for an individual, the program including a personal profile of the individual, a listing of questions relating to the specific business of the software program, a calculating device for calculating the advisory report based upon responses to the listing of questions, and a display of the advisory report for the individual. Also provided is a process of providing an advisory report for an individual by, creating a personal profile for the individual, setting forth questions pertaining to a specific business, monitoring the responses to the questions, and creating an advisory report based on the responses to the questions. A process for providing an employee with access to an employer's business benefits, by creating a personal profile for the individual, setting forth questions pertaining to a specific business, monitoring the responses to the questions and creating an advisory report based on the responses to the questions, which enables the employee to become aware of alternative options available from employer is also provided.

### CROSS REFERENCE TO RELATED APPLICATIONS

This application claims the benefit of priority under 35 USC Section 119(e) of United States Provision Patent Application No. 60/171,038 filed Dec. 16, 1999, incorporated herein by reference.

### BACKGROUND OF THE INVENTION

1. Field of the Invention

The present invention relates to a method and program for providing intranet/web based programs. More specifically, the present invention relates to a method and program for providing business programs accessible to both employers and employees.

2. Description of Related Art

Presently, employees are not given a say regarding their benefits, such as health insurance, life insurance, etc. In a business environment where there is a great deal of competition, there is an increased desire to both provide better benefits and to provide the employees with greater opportunities to create a benefit package that suits their individual needs.

There is presently no system in effect which enables both of the above objectives to be met. While many employers are not providing what they consider to be better benefit packages, these packages still do not necessarily reflect the needs of the individual employees.

It would therefore be useful to develop an intranet/web based communication and marketing program designed to meet the growing needs of employers to retain and recruit current and prospective employees thereby accomplishing both of the above objectives.

### SUMMARY OF THE INVENTION

According to the present invention, there is provided a business software program which provides an advisory report for an individual, the program including a personal profile of the individual, a listing of questions relating to the specific business of the software program, a calculating device for calculating the advisory report based upon responses to the listing of questions, and a display of the advisory report for the individual. Also provided is a process of providing an advisory report for an individual by, creating a personal profile for the individual, setting forth questions pertaining to a specific business, monitoring the responses to the questions, and creating an advisory report based on the responses to the questions. A process for providing an employee with access to an employer's business benefits, by creating a personal profile for the individual, setting forth questions pertaining to a specific business, monitoring the responses to the questions and creating an advisory report based on the responses to the questions, which enables the employee to become aware of alternative options available from employer is also provided.

### DESCRIPTION OF THE DRAWINGS

Other advantages of the present invention can be readily appreciated as the same becomes better understood by reference to the following detailed description when considered in connection with the accompanying drawings wherein:

FIG. 1 is the general scheme of the present invention;

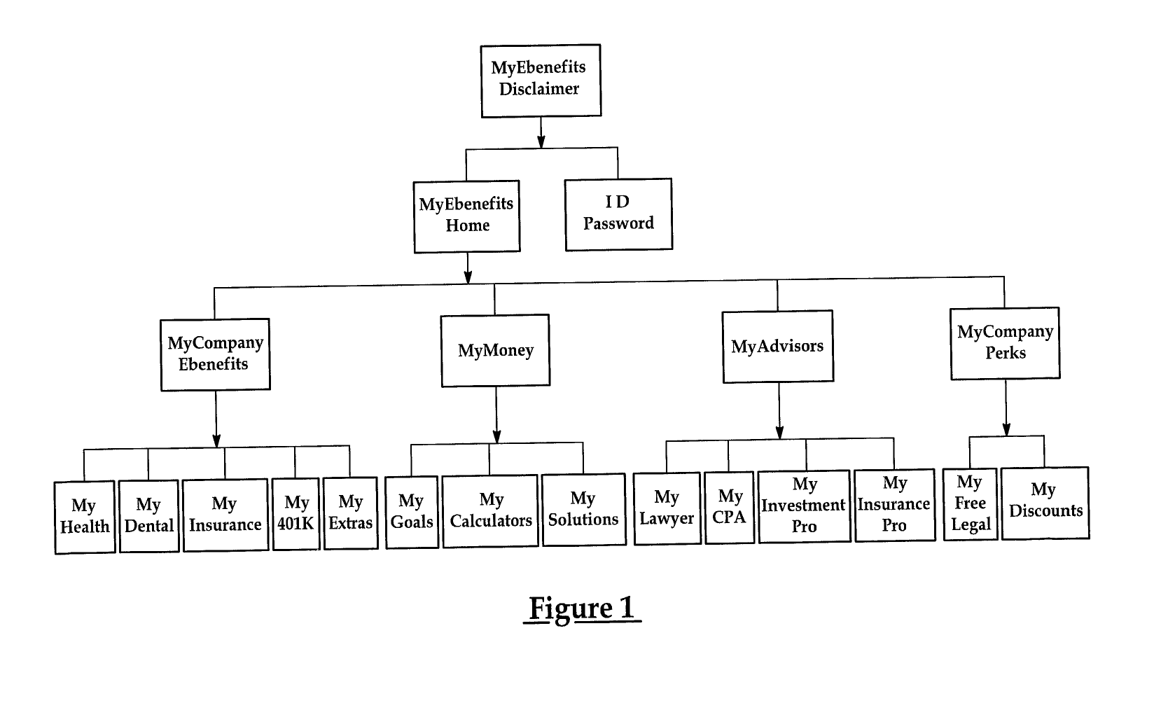

FIG. 2 is the layout and navigational scheme of the present invention; and

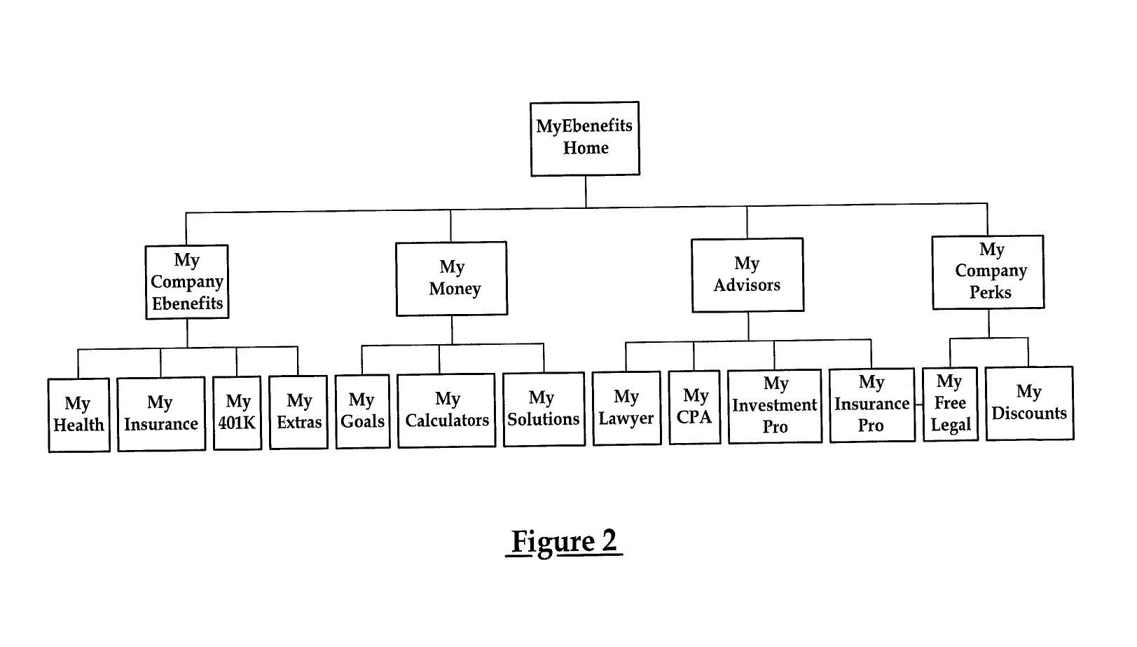

FIGS. 3 A and B are a diagrams showing the models of the present invention.

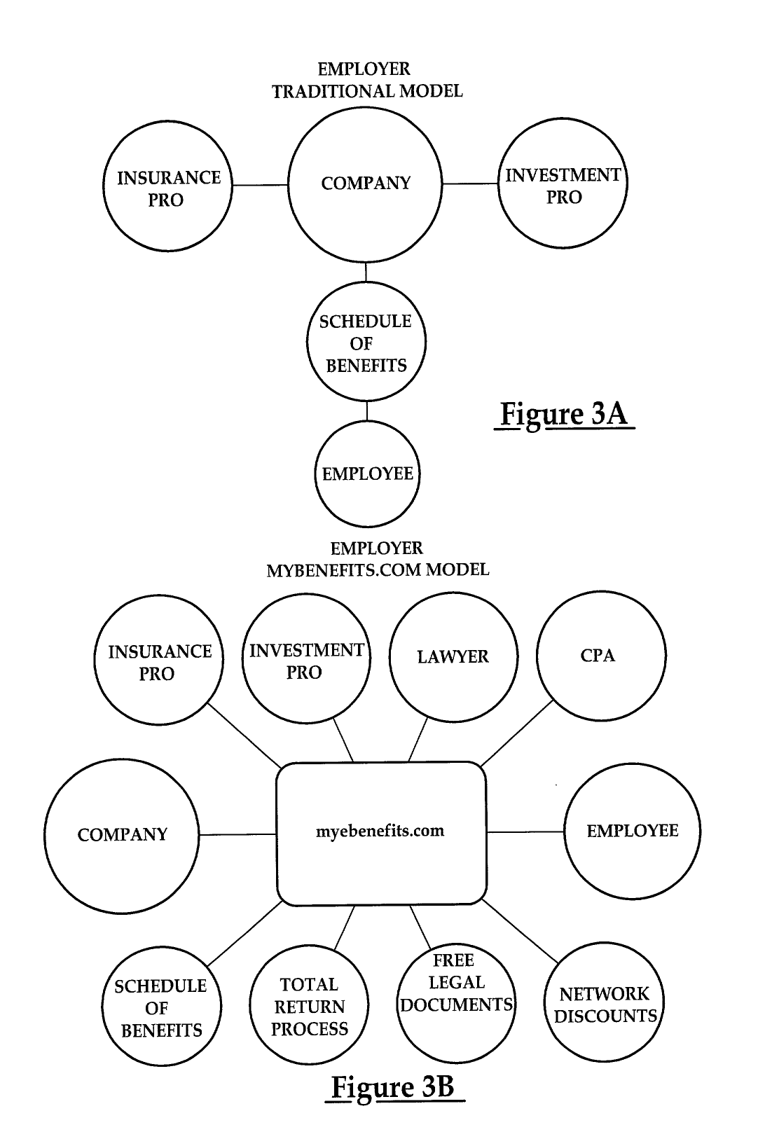

### DETAILED DESCRIPTION OF THE INVENTION

Generally, the present invention provides a business software program, or process, which provides an advisory report for an individual. Preferably, the advisory report provides for an employee a listing of available business benefits that are available to the employee.

The term “individual” as used herein is generally intended to mean an employee. However, it can also refer to any individual who is partaking of the process or software of the present invention, for example a previous employee or a prospective employee.

The term “profile” as used herein is meant to include the general information provided by the individual when beginning the process. This information generally includes, but is not meant to be limited to, retirement information, age, salary, other investments, etc.

The term “Intranet” as used herein is defined to include an internal communication system. The Intranet is used to connect various interlinked local area networks and essentially provides a private version of the Internet.

The term “business benefits” as used herein is defined as items which are beneficial to business. The benefits include, but are not limited to, life insurance, health insurance, 401(k), other business aspects such as stock options. Business benefits can also include anything benefits relative to the business, and thus are anything within the realm of the business.

The process of the present invention is an intranet/web based communication and marketing program designed to meet the growing needs of employers to retain and recruit current and prospective employees. The program has a unique application to the intranet functionality of facilitating, communicating and collaborating information within a defined corporate community.

Internal and private corporate communities have traditionally linked their intranet application with various interlinked local area networks (LANs), and can create a private version of the Internet. Typically, an intranet's main purpose is to share company information and computing resources among employees. An intranet can also be made accessible to customers, partners, suppliers or others outside the company and that is often called an extranet. The method and process of the present invention combines intranet and extranet applications.

More specifically, the software program of the present invention includes a personal profile of the individual, a listing of questions relating to the specific business of the software program, a calculating device for calculating the advisory report based upon responses to the listing of questions, and a display of the advisory report for the individual.

The software program is accessed using the Internet, an Intranet, an Extranet and other electronic devices. By enabling the software to be accessible via electronic devices, the individual can utilize the software at their convenience. The individual can also customize the business benefits to comport with their own desires and needs. Therefore, the individual is able to make the program work specifically for them.

Further, the advisory report generated by the software program can include a selection of options. These options set forth the business benefits available from the employer. By creating a listing of optional benefits the employee can create a package of business benefits from those available by the employer. This capability allows a better business benefits package to become available to employees.

The calculating device has incorporated therein a decision maker. The decision maker makes the determinations which options are available to the employee. Therefore, the decision maker is the tool utilized to create the selection of options.

In a further embodiment of the present invention, the selection of options is electronically connected to a provider of the options. Thus, when the employee indicates the desire to access a particular option the employee can optionally be connected to a provider of such option.

The software program can include a security device. The security device prevents unlawful access to the software and additionally, maintains confidentiality for the employee utilizing the software program.

Also provided by the present invention is a process of providing an advisory report for an individual. This process includes the steps of creating a personal profile for the individual, setting forth questions pertaining to a specific business, monitoring the responses to the questions and creating an advisory report based on the responses to the questions.

In one embodiment of the process, there is included electronic access to the process. The electronic access can include, but is not limited to, Internet, Intranet, Extranet and other electronic methods.

Preferably, the process also includes an access step. The access step limits the ability of non-authorized users for obtaining access to the process. This can include a security step for preventing entry into the process. In the preferred embodiment, the security step includes providing the individuals with a password for use in granting/gaining access to the process.

The present invention also provides a process for providing an employee with access to an employer's business benefits by creating a personal profile for the individual, setting forth questions pertaining to a specific business, monitoring the responses to the questions and creating an advisory report based on the responses to the questions, which enables the employee to become aware of alternative options available from the employer.

The process can also include providing electronic access to the process. The electronic access can include, but is not limited to, Internet, Intranet, Extranet and other electronic methods.

Preferably, the process also includes an access step. The access step limits the ability of non-authorized users for obtaining access to the process. This can include a security step for preventing entry into the process. In the preferred embodiment, the security step includes providing the individuals with a password for use in granting/gaining access to the process.

In another embodiment of the present invention, there is provided a method of providing an employee with business benefit options from an employer, by creating a personal profile for the individual, setting forth questions pertaining to a specific business, monitoring the responses to the questions and creating an advisory report based on the responses to the questions, which enables the employee to become aware of alternative options available from the employer.

The process can include electronic access to the process. The electronic access can include, but is not limited to, Internet, Intranet, Extranet and other electronic methods.

Preferably, the process also includes an access step. The access step limits the ability of non-authorized users for obtaining access to the process. This can include a security step for preventing entry into the process. In the preferred embodiment, the security step includes providing the individuals with a password for use in granting/gaining access to the process.

In one embodiment of the present invention, the process is entitled MyEbenefits.com which is an intranet/web based communication and marketing program designed to meet the growing needs of employers to retain and recruit current and prospective employees. MyEbenefits has a unique application to the intranet functionality of facilitating, communicating and collaborating information within a defined corporate community.

Internal and private corporate communities have traditionally linked their intranet application with various interlinked local area networks (LANs), and can create a private version of the Internet. Typically, an intranet's main purpose is to share company information and computing resources among employees. An intranet can also be made accessible to customers, partners, suppliers or others outside the company and that is often called an extranet.

MyEbenefits combines intranet and extranet applications, however, it defines itself in the following terms:

a. The site is a web based application for employers.

b. MyEbenefits.com is a private label, customizable intranet that features an employer's benefit plan.

c. The site is a unique outsourcing or co-sourcing continuing education format for employees only by combining the Department of Labor Interpretive Bulletin 96 (Investment Advice versus Investment Education) with pragmatic legal, tax, investment and insurance strategies.

d. The site is designed to communicate on a many-to-one basis, however, the “many” variable is directed towards various classification of services.

e. The site is designed to include a process that enables the services to integrate with legal and accounting disciplines that enable the employer/employee to make informed decisions via specific step-by-step directions.

f. The site is “decision-tree” driven in that the employer/employee has been introduced to the MyEbenefits.com Total Return Process. The Total Return Process allows the employee/employer to understand the need to Identify, Analyze, and Diagnose their Financial Portfolio with their Employee Benefit portfolio and thus make an informed financial, business or benefit option decision which, in turn, leads to a Solution. The Total Return Process that MyEbenefits.com communications is the employee's ability to navigate to MySolutions. MySolutions is the employer's advocate for each employee to take a proactive stance in recognizing that an employee benefit package is not limited to just the employer provided benefits. The employee has the ability to utilize MyEbenefits.com in a way that combines the employer's benefits, extras, and perks with the employee's personal portfolio. See the following schematic:

g. The site is a compliance-driven site for employers who can access a professional advisor community. (Attorneys, CPAs, Licensed Insurance Agents and Agencies, Registered Securities Representatives, Registered Investment Advisors and Bank Trust Officers).

h. The site is designed to initiate an appointment with a professional advisor that enables the employee to take the Total Return Process to completion.

i. The site is a unique marketing and sales model for the financial services community in that it can provide product and service shelf space access on an employer's intranet site.

j. The site is a proactive sales prospecting model for the professional advisors listed above. The potential for referred leads increases dramatically with an employer driven education model that encourages a comprehensive and integrated approach to utilizing professional services in conjunction with personal due diligence.

k. The site is designed to include a “perks” incentive feature. The “perks”/Mycompanyperks is a marketing model that negotiations professional service discounts in the areas of legal, tax, investment and insurance. It also includes negotiated savings from existing employer vendors and outside vendors who can demonstrate hard dollar savings on goods and services. The Mycompanyperks navigation bar can also link to specific strategic partners that provide electronic coupons.

The site is a proactive recruiting model for financial services, insurance, legal and accounting professionals. The MyEbenefits.com site is an interactive consultative sales tool that a professional advisor can customize to their client base. The MyEbenefits.com site is designed to generate qualified leads by demonstrating that each advisor can legally, objectively and independently provide educational information in a fashion that does not compromise their core business.

m. This site is designed to let product manufacturers distinguish their features, benefits and results on a direct basis or through a professional advisor sales force. The distinguishing characteristic is that the information is disseminated through the employer's private intranet site.

n. The site is designed to provide directions, not just information. The information comes from the “many” and addresses the “one.”

The above discussion provides a factual basis for the use of the software and process/method of the present invention. The methods used with and the utility of the present invention can be shown by the following non-limiting examples and accompanying figures.

### EXAMPLES

### Example 1

### MYEBENEFITS.COM—PROCESS ALGORITHM

The following process algorithm for myebeneifits.com is based upon the principle that:

1. MYEBENEFITS.COM is a web based application that generates client leads for legal, accounting, investment, and insurance professionals.

2. MYEBENEFITS.COM generates leads for financially related business to business product and service providers.

3. MYEBENFITS.COM recruits professional advisors and generate qualified leads for financial service firms who want to license attorneys and cpa's.

4. MYEBENEFITS.COM defines and execute a process called “the Total Return process”.

More specifically, MYEBENEFITS.COM is a closed intranet communications platform that enlists a decision tree menu of benefits, extras and perks customized by employers for their employees. The intranet site is a step by step customized employer program that leads the employee to a professional advisor, product or service provider. MYEBENEFITS.COM is a delivery system that brings “many to one” and is designed to synchronize the elements within an employee benefit plan that empowers the employee with educational tools to improve mental health, physical health and financial health. The employer communicates, educates and creates a bias for action whereby each employee participates in the MYEBENEFITS.COM Total Return process.

The definition for Total Return is the result of the employer and employee executing a step by step methodology to communicate, educate, participate and compensate each other. The myebenefits.com process algorithm integrates each process whereby the employee, employer, advisor, product or service provider can identify, analyze, diagnose and solve for a “checklist of missed opportunities.” The Total Return is quantified by eliminating the number of missed opportunities or options that an employee experiences in the employers—employee benefit package. In addition to those missed opportunities/options, the employee now can continue to eliminate a consensus of missed opportunities that can be universal or personal within the field of legal, tax, investment and insurance strategies. The last step in the Total Return process allows for these “missed opportunities” to become a bias for action whereby the employee can access product and professional service providers through the myebenefit.com search engine. The incentive to participate in the Total Return process for the employee goes beyond the need to educate. Professional advice includes the ability to access negotiated financial discounts for professional services or receive discounts on a direct basis from a list of product and service providers that have strategically aligned with MYEBENEFITS.COM. The final reason to participate in the Total Return Process is the fact that each party in the process is compensated. Compensation can be defined as financial discounts, electronic coupons, a company “currency” that has an assigned economic value for discounts on professional services and general employee satisfaction The incentive to participate starts with the execution and implementation of an “employers” customized MYEBENEFITS.COM intranet.

The process requires each employee, employer, advisor, product and service provider to communicate, educate, participate and compensate with one another in the Total Return process. The process identifies, analyzes, diagnoses and solves (IADS Process/Total Return) for the goals, objectives and tasks of each category in an employers customized intranet site. Listed below are illustrations of how the communication/education platform integrates with the participation incentive to generate leads for the professional advisor network.

1. Disclaimer Entry Screen—MYEBENEFITS.COM DISCLAIMER - ACCEPT or REJECT in order to proceed forward.

2. User I.D. and Password Screen—Employer I.D. and Employer Password is entered. The employee/user proceeds to the companies (myebenefits.com a benefit that counts) customized site that begins the journey and explains the features, benefits and results that the site intends to bring to the end user. The result in the IADS process for the employee is a Total Return.

3. Welcome screen which describes what the site is and how it works: NEXT STEP: Is a point and click option that leads to the next screen. The user also has the flexibility to navigate within the site by pointing and clicking to anywhere on the navigation bar and the corresponding links.

4. Mycompanybenefits: Mycompany benefits is designed to lead the employee to each benefit category within the employers list of employee benefits. The navigational template breaks down mycompanybenefits into the following categories:

a. Mycompanyhealth—posts employee benefit health options, enrollment procedures and benefit schedules. It identifies the insurance company and links directly to its web site. NEXT STEP:

b. Myinsurance—identifies all the other insurance related benefits specific to each employer. It can include, but is not limited to: Dental, Vision, Life, Long/Short Term Disability or any other employer sponsored insurance program. All information is posted in terms of benefit schedules and a corresponding link to each insurance provider is made available if it exists. NEXT STEP:

c. My401(k) identifies the investment options, contribution levels, and specific vesting schedule of each employer. The My401(k) page introduces a major step in the Total Return process by communicating and educating the employee on the importance of an investment policy statement in terms that an employee understands and appreciates.

The site directly links to the (product provider) mutual fund family, institutional money manager, or agent for investment options within the 401 (k) plan document. The product provider is required to maintain its own security, user identification and password. On line access to the product provider allows the user/employer/advisor to adhere to legislative and industry compliance requirements. NEXT STEP:

d. Myextras identifies a class of benefits that the employer designates as something that goes beyond the benchmark of traditional benefits offered within their industry group. The myextras page is customized to each employers specifications. Myextras allows the employer to “frame” these benefits as value added extras and reinforce a Total Return message that continues to educate the employee. The Total Return can be quantified by providing tools and benefits that improve the employees mental and physical health. NEXT STEP

e. MYMONEY identifies with the employees desire to access a number of quantitative steps and calculation devices that leads to a Total Return solution. The integration of quantitative goals can be measured by navigating to mycalculators. The integration of qualitative tools can be initiated through mysolution. The combination of educational tools available through the use of mygoals and mycalculators leads to the decision of what becomes mysolutions. NEXT STEP

f. Mygoals is the employee's interpretation of “what is important about money to me?” The introduction of the investment policy statement for a second time is a step by step action plan whereby the employee begins the journey toward fulfilling a Total Return. A glossary of terms and a series of questions provide a template for the investment policy statement. The IPS becomes a “dynamic” tool for the employee to look beyond past performance of investments. The IPS becomes a “dynamic compliance tool” for employers with respect to the DOL (96) Bulletin for Investment Advice versus Investment Education.

The IPS becomes a required compliance function for the registered representative/insurance professional who must adhere to the National Associations of Securities Dealers (NASD) requirement for suitability, disclosure, prudent person rules and all other applicable compliance regulations. NEXT STEP

g. Mycalculators is the employee's hot link to mathematical equations that reflect a desire to quantify the employees financial goals, objectives and tasks. Mycalculators is a dynamic option within the site and is always subject to upgrades due in part to changes in the tax law. NEXT STEP

h. Mysolution is the deductive reasoning process that results in reaching the final steps necessary to achieve a Total Return. The mysolution page is designed to let the employee reflect on the employer's desire to communicate and educate. The employee can now decide at what level they want to participate in the Total Return process and activate the lead generation process. The employers educational curriculum of information creates the impetus for the employee to access a professional advisor. The Total Return process has been activated to include the checklist of missed opportunities that each advisor presents, on line or in person. The next step is allowing the employee an opportunity to participate in a dynamic and holistic approach to understanding and executing a Total Return process. The solution is to provide the tools and resources to financially self actualize under a Total Return framework. NEXT STEP

i. MYADVISORS is the employees link to a financial preferred provider network. The network initially includes attorneys, CPA's, investment and insurance professionals. MYEBENEFITS.COM can also expand the list of professionals to include subcategories of professionals and specialists in the field of medicine, dental, mental health, and physical health. Myadvisors are subcontractors to myebenefit.com and are required to adhere to a myebenefits.com code of conduct in addition to their respective professional code of conduct. The accessibility and availability of these professional advisors during the step by step Total Return process facilitates the employee's desire to financially self actualize. Each advisor is updating and integrating their “checklist of missed opportunities” within the context of the Total Return process. The compensating factor associated with the professional advisor group is their ability to participate in the financial services revenue model of fees and commissions as well as any additional legal, tax, investment, or insurance consulting services. Each advisor is subject to a MYEBENEFITS.COM peer review committee. NEXT STEP

Note: An employer can choose to integrate their own professional network in addition to the MYEBENEFITS.COM preferred provider network.

j. Myattorney is the employee's link to estate and tax planning techniques and strategies. The myattorney network is designed to educate the employee on the variety of legal devices that are available and how they work. The checklist of missed opportunities creates the impetus for the employee to participate in the legal process and complete one the most important steps in the Total Return process. NEXT STEP

k. MyCPA is the employees link to tax planning techniques and strategies. The myCPA network is designed to educate the employee on the benefits of tax planning strategies that consistently match the employees legal, investment and insurance strategies. The checklist of missed opportunities creates the impetus for the employee to participate in the accounting/tax process and complete another step in the Total Return process. NEXT STEP

l. MyInvestmentProfessional is the employees link to an experienced investment professional who can address a variety of proven investment strategies. The MyinvestmentProfessional network is designed to educate the employee on the benefits of an investment policy statement, asset allocation, portfolio diversification, and risk tolerance. The MyinvestmentProfessional determines, with the employee, where the employee is in their own economic life cycle. The checklist of missed opportunities reflects the employees desire to accumulate, preserve or distribute assets in their investment portfolio. The MyinvestmentProfessional also integrates those investment strategies that maximize the legal and tax ramifications that the legal and tax professional have suggested in order to achieve a Total Return. NEXT STEP

m. MyInsuranceProfessional is the employees link to an experience insurance professional who can identify, analyze and diagnose an employees existing insurance portfolio. The MyInsuranceProfessional network is designed to educate the employee on the fundamentals of risk management, income protection and wealth protection devices. The checklist of missed opportunities reflects the employees desire to build wealth and protect it along the way, or if the employee has wealth and wants to protect it along the way. MyInsuranceProfessional integrates the techniques and strategies that compliment and maximize the legal, tax, and investment strategies that assist the employee in achieving a Total Return. NEXT STEP

n. MyProductProvider is the employees link to a financial services product search engine. The “product follows the process.” The professional advisor network in conjunction with the employer acts as a “human browser” in searching for the most cost effective financial services product. The human browser element does not have a predisposition to any particular product based on product compensation methods. The product portfolio reflects a “best of class” profile. The employee, employer and professional advisor is able to select from a comprehensive menu of financial products. The ability of the employer and employee to make an informed business decision that coincides with the integrity of the advice provided results in an objective product decision and solution. (The product provider is woven into the site pages where a product is approved by the employer.) The product provider can be represented by the corresponding benefit schedule and links directly to the product vendors site if available. Example: Health Insurance—Blue Cross/Blue Shield of Michigan.

o. MyServiceProvider is the employees link to related services that extend the benchmark level of benefits, extras and perks that currently exist within each employers customized site. The introduction of MyServiceProvider reflects MYEBENEFITS.COM strategic alliance with selected service provider who provides discounts and incentives to employees whose services are otherwise be less affordable. The MyServiceProvider list can include Employee Assistance Programs (EAP's) for mental health, Health Club Memberships for physical health, and access to financial e-commerce discounts for financial health.

p. MYCOMPANYPERKS is the incentive and compensation method that fuels the employers desire to communicate, educate and have the employee participate in the Total Return process. The employer can communicate to the employee population that it is their responsibility to be held to a higher standard when it comes to educating the employee on the employee benefit program. The customized MYEBENEFITS.COM company curriculum includes an understanding that when the employee participates in the Total Return process that they are compensated. The mycompanyperks mechanism includes an option to create a “currency” or “means of exchange” (Company Spokesdollars). The currency speaks to fact that “money counts” and reflect myebenefits tag line of “a benefit that counts”. Mycompanyperks is tangible proof that an employee has some of the same legal, tax, investment and insurance opportunities, privileges and perks that the President of their company enjoys. NEXT STEP

### Example 2

### EMPLOYEE

### Communicate

MyEbenefits.com allows the employee to speak to their needs for mental, physical and financial health.

### Educate

The employee determines the curriculum that serves their needs, wants and desires.

### Participate

The employee has a choice to access professional advisors who identify, analyze, diagnose and solve for a legal, tax, investment and insurance checklist of missed opportunities.

### Compensate

The employee executes a Total Return process. In order to facilitate the Total Return process, the employer and myebenefits.com constructs a series of financial incentives that create a bias for action. Compensation for the employee is in the form professional advisor discounts, industry product and service discounts. The phrase “a benefit that counts” has value. The employee creates a value for becoming financially self actualized in knowing that the Total Return process integrates people knowledge with process and product knowledge.

### EMPLOYER

### Communicate

MyEbenefits.com allows the employer to speak to their employees “another way”. The employer can communicate a “message that counts.” Employers communicate the features and benefits of a 24/7 electronic communications platform. The employer can communicate to the employee a fiduciary role that speaks to the “Total Return process”and complies with the Dept. of Labors Interpretive Bulletin (96)—Investment Advice versus Investment Education. Employers can establish and communicate an economic benefit to the employers portfolio of benefits, extras and perks.

### Educate

The employer can create a curriculum that is specific to their desire to retain and recruit best of class employees. The employer can educate the employee by posting benefit information that is personal and relevant. The employer can provide directions to legal, tax, investment and insurance professionals who represent the person and not the product.

### Participate

The employer participates in the compliance function surrounding the Dept. of Labors Interpretive Bulletin 96 that sets forth four safe harbor provisions for investment advice versus investment education. The employer designs their customized intranet in their own image and actively promote the “what it is and how it works” environment of benefits, extras, and perks. The employer is the catalyst in the Total Return Process and initiates a bias for action for an employees need to participate in the Total Return Process.

### Compensate

The employer is compensated in a number of ways. The need to meet and exceed customer expectations must transcend to the employer employee relationship. The employer is granted permission to enter into the employees world. Employers become productive and profitable if their basic needs of employment exceed pure dollars and cents. Employers can prove to the employee in terms of a Total Return process as to what is personal and relevant to the employee. Employers reap rewards in the area of employee goodwill, retention and recruitment.

### ADVISORS

### Communicate

The employer is able to communicate to their employees the importance of a competent and objective investment advisor. The advisor network (attorney, CPA, investment professional and insurance professional) communicates the fact that they represent the employee; not the product.

### Educate

The advisor educates the employee relative to their professional discipline, however the education process is fixated on the Total Return Process. The ability to integrate legal, tax, investment, and insurance strategies is paramount to achieving a Total Return.

### Participate

Each advisor prepares and post a “checklist of missed opportunities” that are complimentary to other advisor disciplines or independent of those disciplines. Each advisor subscribes to the IADS process and identify, analyze, diagnose and solve for any employee who chooses to access the professional advisor network.

### Compensate

Each advisor needs the required insurance and investment licenses to business in the employer resident State. Each advisor provides a list of core services that are free to the employee. The services that go beyond the core level of services are available to the employee at a negotiated discount. The advisor is compensated through their ability to compete. The advisor is the beneficiary of the myebenefits.com lead generation program. The advisor is able to participate in the investment advisory fee business and any commission related transactions where legally available. The introduction of a “professional wrap fee” account is an opportunity to integrate professional services under an all in one (1) fee environment and pay for these services through asset management fees. Each advisor participates in a pro-rata share of the revenue.

### MYEBENEFITS.COM

### Communication

Myebenefits.com is a customized intranet consultant that has transformed the complexity of employee benefits, financial services, insurance, legal and tax jargon into a simplified web based application. Myebenefits.com speaks to an employers need to create greater value and understanding in the employer—employee relationship.

### Education

Myebenefits.com is a human browser and search engine for the Total Return Process. Myebenefits.com searches for the quantitative and qualitative tools necessary to improve the educational curriculum of employees, employers, advisors and product providers. Myebenefits.com engages in strategic alliances with other professional advisors in order to identify, analyze, diagnose and solve for each employers desire maximize benefits and minimize costs.

### Participation

Myebenefits.com is an either direct or indirect participant in the communication and educational process. Myebenefits.com looks to participate with product and service providers who compliment the core focus of the employers site. The core focus emphasizes “a benefit that counts”, a “Total Return” and those resources that have been perceived as only available to the classes and not the masses. Myebenefits.com is the virtual consultant and conduit for people knowledge, process knowledge and product knowledge

### Compensation

MyEbenefits.com direct compensation sources includes asset based management fees, commissions, consulting service fees, license fees, advertising.

Throughout this application, various publications, are referenced by author and year. Full citations for the publications are listed below. The disclosures of these publications in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A business software program which provides an advisory report for an individual, said program comprising;
a personal profile of the individual;
a listing of questions relating to the specific business of said software program;
calculating means for calculating the advisory report based upon responses to said listing of questions; and
a display of the advisory report for the individual.

2. The software program according to claim 1, wherein said software program is accessible through means selected from the group consisting essentially of the Internet, Intranet, Extranet and electronically.

3. The software program according to claim 2, wherein said advisory report includes a selection of options.

4. The software program according to claim 3, wherein said selection of options is electronically connected to a provider of said options.

5. The software program according to claim 1, wherein said software further includes security means for gaining access to said software.

6. The software program according to claim 1, wherein said individuals are selected from the group consisting essentially of employees and employers.

7. A process of providing an advisory report for an individual by;
creating a personal profile for the individual;
setting forth questions pertaining to a specific business;
monitoring the responses to the questions; and
creating an advisory report based on the responses to the questions.

8. The process according to claim 7, wherein said process includes providing electronic access to said process.

9. The process according to claim 8, wherein said access step further includes a security step for preventing entry into the process.

10. The process according to claim 9, wherein said security step further includes providing the individuals with a password granting access to said process.

11. A process for providing an employee with access to an employer's business benefits, by:
creating a personal profile for the individual;
setting forth questions pertaining to a specific business;
monitoring the responses to the questions; and
creating an advisory report based on the responses to the questions, which enables the employee to become aware of alternative options available from employer.

12. The process according to claim 11, wherein said process includes providing electronic access to said process.

13. The process according to claim 12, wherein said access step further includes a security step for preventing entry into the process.

14. The process according to claim 13, wherein said security step further includes providing the employee with a password granting access to said process.

15. The process according to claim 11, wherein said process further includes establishing a connection between the employer and the employee such that the employee can determine which aspects of employers business benefits they can be utilized.

16. A method of providing an employee with business benefit options from an employer, by:
creating a personal profile for the individual;
setting forth questions pertaining to a specific business;
monitoring the responses to the questions; and
creating an advisory report based on the responses to the questions, which enables the employee to become aware of alternative options available from employer.

17. The method according to claim, 16, wherein said method includes providing electronic access to said process.

18. The method according to claim 17, wherein said access step further includes a security step for preventing entry into the process.

19. The method according to claim 18, wherein said security step further includes providing the employee with a password granting access to said process.
